(19) United States
(12) Patent Application Publication
(10) Pub. No.: US 2011/0195264 A1
(43) Pub. Date: Aug. 11, 2011

(54) Acicular Metal Particles Having a High Aspect Ratio and Non-Catalytic Methods for Making the Same

(75) Inventor: Chitradurga L. Rao Aravinda, Bangalore (IN)

(73) Assignee: LAIRD TECHNOLOGIES, INC., Chesterfield, MO (US)

(21) Appl. No.: 13/122,719

(22) PCT Filed: Oct. 13, 2009
(86) PCT No.: PCT/US09/60492

§ 371 Date: Apr. 5, 2011

(30) Foreign Application Priority Data
Oct. 14, 2008 (IN) 2501/CHE/2008

(51) Int. Cl. B32B 5/16; B22F 9/18; B05D 5/12; B05D 3/06; H01B 1/22

(52) U.S. Cl. 428/546; 75/370; 75/371; 427/58; 427/553; 427/558; 427/551; 428/328; 252/512

(57) ABSTRACT

A non-catalytic method for making high aspect ratio metal particles comprises: mixing a preheated metallic salt solution with a preheated reducing solution, the reducing solution comprising a carboxylic acid or salt thereof and an acrylic copolymer; and heating the reaction mixture to a first temperature and maintaining the mixture at the first temperature for a first period of time, then heating the reaction mixture to a second temperature that is higher than the first temperature and maintaining the mixture at the second temperature for a second period of time. The metal cations in the metallic salt are reduced by the reducing solution to form a plurality of crystallized metallic particles having a high aspect ratio. Electrically conductive articles incorporating the high aspect ratio metal particles and methods for their manufacture are also provided.

### CROSS-REFERENCE TO RELATED APPLICATION

This application is a PCT International Application of (and claims priority to) India Application No. 2501/CHE/2008 filed Oct. 14, 2008. The entire disclosure of the above application is incorporated herein by reference.

### BACKGROUND

This section provides background information related to the present disclosure which is not necessarily prior art.

The present technology relates to high aspect ratio acicular or needle-shaped metallic particles, methods for making the same, and articles produced therefrom.

Finely dispersed metal particles of controlled composition, shape and size finds extensive application in electronic industry to produce multilayer ceramic capacitors, conductive inks, and conductive pastes due to their high electrical conductivity, excellent solderability, and low material cost. Atomization, chemical reduction methods, electrolysis, and vapor phase processes are in vogue to produce metal particles. Various reducing agents such as hydrazine hydrate, starch, and glucose are used as reducing agents in chemical reduction methods.

A variety of methods have been used to prepare metal flakes or metal platelets, for example, silver flakes, using the methods such as vertical freezing, ball milling, epitaxial growth, gas evaporation, vacuum deposition, Langmuir-Blodgett films, and chemical precipitation. The silver flakes used in the electronic industry are almost exclusively produced by milling silver powders in various solvents in the presence of suitable lubricants (see as an example U.S. Pat. No. 4,859,241 to Grundy). Silver particles milled using the above procedure result from mechanical forces (shear and impact) provided by the movement of the milling media, which usually contains 1-5 millimeter (mm) spheres of materials of different densities and compositions (glass, stainless steel, or ceramics). Because the majority of the silver powders used in the milling process contain large agglomerates of sub-micrometer or micrometer size particles, milling almost always leads to the formation of silver flakes with large average particle sizes (5-20 microns (μm)) and broad size distributions.

The most commonly used chemical reduction method for preparing metal powders to date is the so called polyol process which employs polyhydric alcohols such as glycerol or ethylene glycol. However, these methods can only produce granular particles having a low aspect ratio.

### SUMMARY

This section provides a general summary of the disclosure, and is not a comprehensive disclosure of its full scope or all of its features.

In one aspect, the present technology provides a non-catalytic method for making high aspect ratio metal particles, the method comprising: mixing a preheated metallic salt solution with a preheated reducing solution, the reducing solution comprising a carboxylic acid or salt thereof and a dispersing agent, to form a reaction mixture; and heating the reaction mixture to a first temperature and maintaining the mixture at the first temperature for a first period of time, then heating the reaction mixture to a second temperature that is higher than the first temperature and maintaining the mixture at the second temperature for a second period of time. The metal cations in the metallic salt are reduced by the reducing solution and form a plurality of crystallized metallic particles having a high aspect ratio.

In a further aspect, the present technology provides for an electrically conductive article, the article comprising: a non-conductive substrate; and an electrically conductive coating disposed on at least one surface of the substrate. The coating includes a matrix material having a plurality of metal particles, the metal particles being made by: mixing a preheated metallic salt solution with a preheated reducing solution, the reducing solution includes a carboxylic acid or salt thereof and an acrylic copolymer; and heating the reaction mixture to a first temperature and maintaining the mixture at the first temperature for a first period of time, then heating the reaction mixture to a second temperature that is higher than the first temperature and maintaining the mixture at the second temperature for a second period of time. The metal cations in the metallic salt are reduced by the reducing solution and form a plurality of crystallized metallic particles having a high aspect ratio. The metallic particles produced have an acicular shape with an aspect ratio ranging from 5 to 50.

The articles thus produced by the methods disclosed herein can include electrically conductive tapes, conductive polymeric films, and conductive adhesives, all including high aspect ratio metallic acicular particles.

In another aspect, the present technology also provides methods for making a conductive article. The method comprises synthesizing a plurality of high aspect ratio metallic particles by mixing a carboxylic acid or salt thereof with a dispersing agent to form a reducing solution; adding a metallic salt solution to the reducing solution to form a precipitation mixture; the reducing solution reduces metal ions provided by the metallic salt solution to crystallize a plurality of high aspect ratio metallic particles; heating the reaction mixture to a temperature between about 50° C. and about 80° C.; and collecting the plurality of high aspect ratio metallic particles from the precipitation mixture. A matrix material is added to the plurality of metallic particles thereby forming a conductive paste. Finally, the conductive paste is applied to at least one surface of a substrate.

A further aspect of the present technology provides acicular metal particles having an aspect ratio greater than 5.

Further areas of applicability will become apparent from the description provided herein. The description and specific examples in this summary are intended for purposes of illustration only and are not intended to limit the scope of the present technology.

### DRAWINGS

The drawings described herein are for illustrative purposes only of selected embodiments and not all possible implementations, and are not intended to limit the scope of the present technology.

FIG. 1A depicts a scanning electron microscope photomicrograph of acicular copper particles having a high aspect ratio made in accordance with the methods of the present technology.

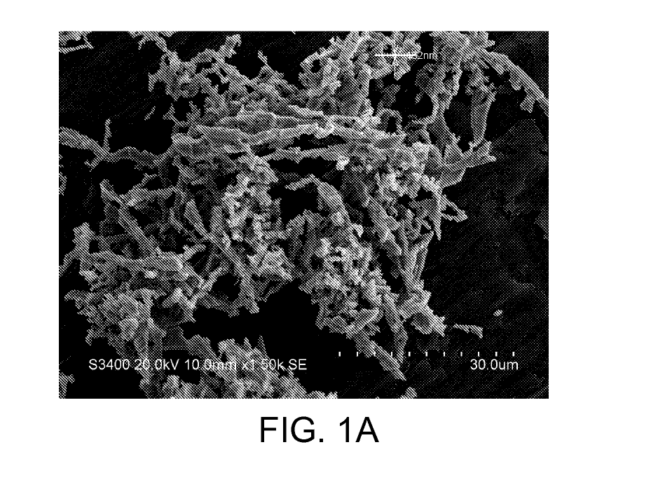

FIG. 1B depicts a scanning electron microscope photomicrograph of acicular copper particles having a high aspect ratio photographed at higher magnification compared with FIG. 1A, made in accordance with the methods of the present technology.

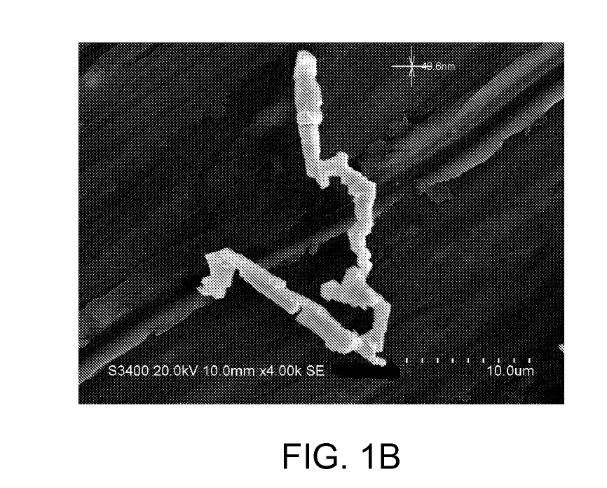

FIG. 1C depicts a scanning electron microscope photomicrograph of acicular silver particles having a high aspect ratio made in accordance with the methods of the present technology.

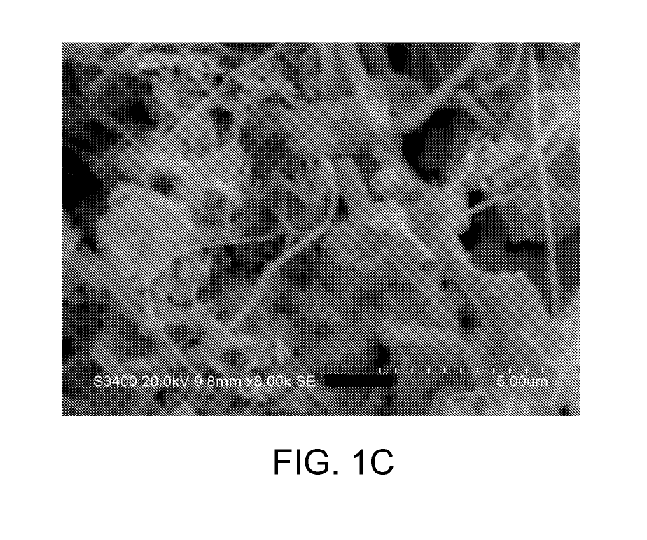

Corresponding reference numerals indicate corresponding parts throughout the several views of the drawings.

It should be noted that the figures set forth herein are intended to exemplify the general characteristics of materials and methods among those of the present technology, for the purpose of the description of certain embodiments. These figures may not precisely reflect the characteristics of any given embodiment, and are not necessarily intended to define or limit specific embodiments within the scope of this technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Background” and “Summary”) and sub-headings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. Any discussion of the content of references cited in the Introduction is intended merely to provide a general summary of assertions made by the authors of the references, and does not constitute an admission as to the accuracy of the content of such references. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

Although the open-ended term “comprising,” as a synonym of terms such as including, containing, or having, is used herein to describe and claim the present invention, the invention, or embodiments thereof, may alternatively be described using more limiting terms such as “consisting of” or “consisting essentially of” the recited ingredients. Thus, for example, in some embodiments, a non-catalytic method for making high aspect ratio metal particles, according to the present invention comprises: mixing a preheated metallic salt solution with a preheated reducing solution, the reducing solution comprising a carboxylic acid or salt thereof and an acrylic copolymer; and heating the reaction mixture to a first temperature and maintaining the mixture at the first temperature for a first period of time, then heating the reaction mixture to a second temperature that is higher than the first temperature and maintaining the mixture at the second temperature for a second period of time, wherein metal cations in the metallic salt are reduced by the reducing solution and form a plurality of crystallized metallic particles having a high aspect ratio.

The inventor hereof has recognized that metal particles, including copper and silver, with high aspect ratio and high electrical conductivity are desirable to use as fillers in polymer matrices to produce electrically conductive elastomers such as conductive tapes and adhesives for electromagnetic interference shielding applications with relatively low filler content. The inventor hereof has also recognized that processes exist for producing large particle size flakes. But the inventor hereof has further recognized that there is a need in the art to produce metallic particles having aspect ratios above 5-10, for example, in the form of acicular metal particles, uniform rods, and needles that can be produced economically on a commercial scale. Accordingly, the inventor hereof has disclosed embodiments herein of methods for making metallic particles having a high aspect ratio, and metallic particles produced thereby are provided. In some embodiments, the metallic particles produced using the methods provided herein can have a substantial number of metallic particles having an aspect ratio greater than 5, greater than 8, greater than 10, greater than 12, greater than 15, or greater than 20. In some embodiments, the aspect ratio of the metallic particles produced using the methods of the present technology can range from about 5 to about 50, or from about 9 to about 40. As used herein, the aspect ratio of the metallic particles can be calculated as the ratio of its longer (x) dimension to a shorter (y) dimension, where the x- and y-dimensions are substantially perpendicular in a common plane. It is understood that the particles comprising any given plurality of particles may comprise a variety of shapes and dimensions, such that the aspect ratios and other dimensions discussed herein are, (in some embodiments) median or (in the same or other embodiments) average, dimensions in a plurality of particles have a distribution of dimensions. In some embodiments, the present technology provides for a non-catalytic method for making non-silver acicular metal particles, where the method includes mixing a preheated metallic salt solution with a preheated reducing solution. The reducing solution comprises a carboxylic acid or salt thereof and an acrylic copolymer. In this example, the method also includes heating the precipitation mixture to a temperature between about 50 degrees Celsius (° C.) and about 80° C., wherein the metal cations in the metallic salt are reduced by the reducing solution and form a plurality of crystallized non-silver metallic particles having an acicular shape.

In some embodiments, the methods of the present technology can be used to form metallic particles which include metal particles of the Groups 8-12 (IUPAC) or Groups VIIIB, IB and IIB (CAS) of the periodic table. The metal particles can include gold, silver, platinum, copper, iron, palladium, cobalt, nickel, zinc, and alloys thereof. The metallic salt solution can contain metal-containing ions which include, for example, Cu⁺, Cu²⁺, Cu³⁺, Cu(NH₃)₄²⁺, Ni³⁺, Pd²⁺, Pd⁴⁺, Pt²⁺, Pt⁴⁺, Au⁺, Au³⁺, Zn²⁺, Cd²⁺, Fe²⁺, and Fe³⁺. In some embodiments, the metallic salt solution can comprise the aforementioned metal ion with anionic species that are part of simple anions, oxoanions, and organic acid anions. The metallic solution can be in the form of solid crystals or aqueous solutions. In some embodiments, the anion species which form the metallic salt can include: Cl⁻, OH⁻, NO₃⁻, NO₂⁻, PO₄³⁻, PO₃³⁻, HPO₄²⁻, H₂PO₄⁻, MnO₄⁻, SO₄²⁻, SO₃²⁻, CO₃²⁻, CrO₄²⁻, HCO₂⁻, C₂H₃O₂⁻, and C₂O₄²⁻.

The methods of the present technology include synthesizing acicular and/or rod and/or ribbon shaped metallic particles by bringing into reaction a metallic salt solution with a reducing solution thereby forming a precipitation mixture. In some embodiments, the metallic salt solution and the reducing solution can be preheated to a temperature ranging from about 40° C. to about 50° C. prior to their admixture. The pH of the metallic salt solution can be adjusted to between about 0.5 to about 5.

The reducing solution provides the chemical precipitation capability to precipitate the metal cations in the metallic salt solution into solid metal particles. The reducing solution converts the metal ions to metal atoms. The reducing solution of the present technology can be prepared by combining an organic acid with a dispersing agent. Alternatively, the reducing solution is a solution of the carboxylic acid without the dispersing agent. The carboxylic acid and the dispersing agent can be added to the metallic salt solution sequentially. The reducing solution can be prepared by adding an amount of solid carboxylic acid, for example, L-ascorbic acid and dissolving the acid in a volume of deionized water. To the aqueous carboxylic acid solution, a volume of a dispersing agent is added to form the reducing solution.

In some embodiments, the reducing solution can be prepared by adding a carboxylic acid with a dispersing agent. The ratio of carboxylic acid to dispersing agent can range from 1:100 to 100:1. Preferably, the concentration of the metallic salt solution to be added to the reducing solution can range from about 1×10⁻⁵ Molarity (M) to about 1×10⁻² M providing a final concentration of the metallic salt solution in the final mixture ranging from about 2 M to about 1×10⁻³M. In some embodiments, the concentration of the carboxylic acid to be added to the metallic salt solution ranges from about 5×10⁻¹ M to about 5×10⁻⁵ M providing a final concentration of the carboxylic acid in the mixture ranging from about 5×10⁻² to about 5×10⁻⁵ M. In some embodiments the final concentration of the dispersing agent in the final mixture ranges from about 5×10⁻² M to about 5×10⁻⁵ M.

The reducing solution can include at least one organic acid and/or salt thereof. The organic acid can include an organic carboxylic acid, for example, L-ascorbic acid or a salt thereof. The reducing solution further contains a dispersing agent. The dispersing agent can include a polymer or copolymer.

The dispersing agent can include a poly(ether ester) wherein the poly(ether ester) can include any one or more of a poly(dioxanone), a polyanhydride, an acrylic polymer, a (meth)acrylic polymer, a polyolefin and copolymers thereof. In some embodiments, the dispersing agent can include one or more ethylenically unsaturated carboxylic acids, such as acrylic acid, methacrylic acid, tricarboxy ethylene or derivatives thereof, such as acrylamide, methacrylamide, acrylic esters and methacrylic esters. Acrylic acid and methacrylic acid are particularly preferred monomers. Acrylic acid is most preferable. The acrylic copolymer can be in the form of a water soluble acrylic polymer salt having a molecular weight ranging from about 4,000 Daltons to about 400,000 Daltons. The acrylic copolymer can include two monomers from the group of methacrylic acid, acrylic acid, methylmethacrylate, butyl acrylate, butyl methmethacrylate, and copolymers thereof. In some embodiments, the dispersing agent is a sodium or ammonium salt of an acrylic copolymer. An illustrative example of such an anionic sodium salt dispersant is Dispex A-40 (Ciba, Switzerland) a low molecular weight (4,000 Daltons) sodium polyacrylate. An illustrative example of an anionic ammonium salt dispersant is Dispex N-40 (Ciba, Switzerland) a low molecular weight (6,000 Daltons) ammonium polymethacrylate. Discoat N-14 (Dai-ichi Kogyo Seiyaku Co., Ltd.) is an example of a high-molecular polycarbonic acid dispersant. In some embodiments, the acrylic copolymer has a viscosity of about 400 megapascals to about 600 megapascals at 25° C. The relative density of the acrylic copolymer used as a dispersing agent can range from about 1.1 to about 1.4 grams per cubic centimeter (g/cm³). In some embodiments, the metallic particles are formed after the reducing solution and the metallic salt solution are mixed together thereby forming a precipitation mixture.

Typically, to control the yield and/or shape of the precipitated metallic particles, the reaction mixture can be heated to a first temperature and maintaining the mixture at the first temperature for a first period of time. The reaction mixture can be heated to a first temperature ranging from about 50° C. to about 80° C., or from about 50° C. to about 75° C., or from about 50° C. to about 70° C., or from about 50° C. to about 65° C., or from about 50° C. to about 60° C., or from about 55° C. to about 80° C. or from about 60° C. to about 80° C. or from about 65° C. to about 80° C. or from about 70° C. to about 80° C. The reaction mixture can be maintained at the first temperature for a first period of time ranging from about 30 minutes to about 120 minutes, or from about 30 minutes to about 100 minutes, or from about 30 minutes to about 90 minutes, or from about 30 minutes to about 70 minutes, or from about 30 minutes to about 60 minutes, or from about 30 minutes to about 40 minutes, or from about 50 minutes to about 120 minutes, or from about 60 minutes to about 120 minutes, or from about 80 minutes to about 120 minutes, or from about from about 90 minutes to about 120 minutes. Then the reaction mixture is heated to a second temperature that is higher than the first temperature and maintaining the mixture at the second temperature for a second period of time. The second temperature can range from about 55° C. to about 90° C., or from about 60° C. to about 90° C., or from about 70° C. to about 90° C., or from about 60° C. to about 90° C., or from about 60° C. to about 85° C., or from about 60° C. to about 80° C., or from about 60° C. to about 75° C. The second temperature can be maintained for a second period of time. The second period of time can be the same as the first period of time, or the second period of time can be different to the first period of time. The second period of time can range from about 30 minutes to about 120 minutes, or from about 30 minutes to about 100 minutes, or from about 30 minutes to about 90 minutes, or from about 30 minutes to about 70 minutes, or from about 30 minutes to about 60 minutes, or from about 30 minutes to about 40 minutes, or from about 50 minutes to about 120 minutes, or from about 60 minutes to about 120 minutes, or from about 80 minutes to about 120 minutes, or from about from about 90 minutes to about 120 minutes.

After the precipitation solution has been mixed for at least a portion of the first and/or second periods of time, the precipitated metallic particles are recovered from the precipitation mixture using a variety of isolation techniques, including, for example, filtration, sedimentation, centrifugation, and magnetic separation.

In some embodiments, the metallic particles are recovered from the precipitation mixture using a Büchner funnel having an appropriate filter attached to a vacuum source. Laboratory methods for recovering particles using a Büchner funnel include those described in Shapiro J, “High-Rate Laboratory Filtration with Büchner Funnels,” Science (1961);133(3467):1828-1829. In some embodiments, the filters used to capture the acicular high aspect ratio metallic particles having a first (x) dimension ranging between about 0.1-10 microns (μm) and a second (x) dimension ranging between about 1-100 μm are commercially available from Millipore, Billerica, Mass. and from Whatman Kent, UK. The solid metallic particles of the present technology can be washed after separation from the precipitation mixture with water until the conductivity of the wash water is 20 micro ohms (μohms) or less. Optionally, the isolated metallic particles can be washed with an organic solvent such as a small chain alcohol. The water and/or solvent can then be removed from the metallic particles and the particles dried.

### Applications

The high aspect ratio metallic particles of the present technology may be used in a variety of electroconductive applications. In some embodiments, the isolated metallic particles are used as a coating for various substrates. Methods for making a conductive article can include the steps of coating a conductive paste on at least one surface of a substrate. The method includes synthesizing a plurality of high aspect ratio metallic particles. The synthesis includes mixing a carboxylic acid or salt thereof with a dispersing agent to form a reducing solution and adding a metallic salt solution to the reducing solution to form a reaction mixture. The reducing solution reduces the metal ions provided by the metallic salt solution to crystallize a plurality of high aspect ratio metallic particles. The method also includes heating the reaction mixture to a temperature between about 50° C. and about 80° C. and collecting the plurality of high aspect ratio metallic particles from the reaction mixture. A matrix material can be added to the plurality of metallic particles, thereby creating a conductive paste. The conductive paste can then be applied to at least one surface of the substrate, thereby creating a conductive article.

The metallic particles can be admixed with a matrix material that can include a binder and optionally a solvent to form a conductive paste that can be applied or coated to a variety of substrates. Coatings employing the metallic particles produced by the methods of the present technology can be applied to conductive and non-conductive substrates useful in the manufacture of multilayer ceramic capacitors, conductive films, and conductive tapes. The metallic particles, and optionally a matrix material and a solvent can be formulated and applied to a variety of transparent and non-transparent films and other surfaces for various optical-electronic devices, such as optical filters for light scattering, radio frequency identification (RFID) tags and labels and microelectromechanical systems (MEMS).

In some embodiments, coatings employing the metallic particles of the present technology are used together with an inherently non-conductive substrate, such as glass and plastic. When the metallic particles are admixed with a matrix material comprising a binder and optionally a solvent, the resultant conductive paste can be coated on a conductive or non-conductive substrate by various coating manners, such as brush coating, spray coating, roll coating, spine coating, printing, sputtering, chemical vapor deposition, and dip coating. Optionally, once the conductive paste has been applied to at least a surface of the substrate the conductive paste can be cured or polymerized and then the article can be dried in an oven set to at least 100° C. for a period ranging between about 30 minutes and about 4 hours.

Any resin can be used as the binder (resin), preferably as long as it has transparency to light from visible light to near infrared light, which is used for coating or molding. Examples of the resin used as the binder include curable and non-curable organic resins, such as acrylic resin, polyester resin, alkyd resin, urethane resin, silicone resin, fluororesin, epoxy resin, polycarbonate resin, polyvinyl chloride resin, polyvinyl alcohol resin, and radical polymerizable oligomers and highly and moderately polar monomers and copolymers thereof (possibly together with a curing agent and/or a radical polymerization initiator).

Examples of the highly polar monomers can include acrylic acid, itaconic acid, hydroxyalkyl acrylates, cyanoalkyl acrylates, acrylamides or substituted acrylamides. Examples of the moderately polar monomer include N-vinyl pyrrolidone, N-vinyl caprolactam, acrylonitrile, vinyl chloride or diallyl phthalate.

Conductive pastes and coatings employing the metallic particles of the present technology can optionally contain a solvent, if necessary. In some embodiments, the solvent includes any solvent which stably dissolves or disperses the binder in the matrix. Examples of suitable solvents for use in the conductive materials of the present technology can include alcohols such as methanol, ethanol, propanol, hexanol, and ethylene glycol; aromatic hydrocarbons such as xylene and toluene; aliphatic hydrocarbons such as cyclohexane; ketones such as acetone and methyl ethyl ketone; esters such as ethyl acetate and butyl acetate; ethers such as ethylene glycol monobutyl ether; and a mixture thereof, in addition to water. However, the solvents useful in the present technology are not limited to these solvents. In some embodiments, the electrically conductive coatings of the present technology may be an aqueous dispersed solution in which metallic particles are dispersed in water.

The matrix component and the metallic particles are present in the conductive paste according to the present invention, in an amount of 10-95 weight percent (wt %) and 5-90 wt %, respectively, based on the total weight of the conductive paste. In some embodiments, the matrix component and the metallic particles are present in the conductive paste according to the present technology, in an amount of 40-80 wt % and 20-60 wt %, respectively, based on the total weight of the conductive paste.

In some embodiments, the conductive paste employing the metallic particles of the present technology can also include other optional additives, including, a polymerization initiator, crosslinking agent, photoinitiator, pigment, antioxidant, UV stabilizer, dispersant, antifoaming agent, thickening agent, plasticizer, tackifying resin, silane coupling agent, brightening agent, and the like.

In some embodiments, the curable binders include one or more acrylate resins, epoxy resins, polydimethyl siloxane resins, other organo-functionalized polysiloxane resins that can form cross-linking networks via free radical polymerization, atom transfer radical polymerization, nitroxide mediated radical polymerization, reversible addition-fragmentation transfer polymerization, ring-opening polymerization, ring-opening metathesis polymerization, anionic polymerization, cationic polymerization, or any other method known to those skilled in the art, and mixtures thereof. Suitable curable binders can include silicone resins, for example, the addition curable and condensation curable matrices as described in “Chemistry and Technology of Silicone,” Noll, W.; Academic Press 1968.

The curing process can be performed by any process known to those skilled in the art. Curing can be done by methods such as thermal cure, UV light cure, microwave cure, e-beam cure, free radical cure initiated with free radical initiators, and combinations thereof. Typical free radical initiators can include, for example, organic peroxides (e.g., benzoyl peroxide), inorganic peroxides (e.g., hydrogen peroxide), organic or inorganic azo compounds (e.g., 2-2′-azo-bis-isobutyrylnitrile), nitroxides (e.g. TEMPO) or combinations thereof.

Curing of the conductive paste and/or matrix material typically occurs at a temperature in a range between about 20° C. and about 250° C., more typically in a range of about 50° C. and about 150° C. In some embodiments, the binders are chosen such that the curing temperature is about 10° C. to about 200° C. Curing typically occurs at a pressure in a range between about 1 atmosphere (atm) and about 5000 pounds pressure per square inch, more typically in a range between about 1 atm and about 100 pounds per square inch (psi). In addition, curing may typically occur over a period in a range between about 30 seconds and about 5 hours, and more typically in a range between about 90 seconds and about 120 minutes. Optionally, the cured conductive paste can be post-cured at a temperature in a range between about 100° C. to about 150° C. over a period of about 0.5 hour to about 4 hours, preferably from about 1 hour to about 2 hours.

The conductive pastes employing the metallic particles of the present technology can also be used to make electrically conductive tapes. In some embodiments, the conductive pastes of the present technology can be coated onto conductive and non-conductive fibers to create a cloth like material that is electrically conductive. Exemplary conductive fibers include micron conductive fibers for example, nickel plated carbon fiber, stainless steel fiber, copper fiber, silver fiber, aluminum fiber, or the like, or combinations thereof. Non-conductive fibers can also include Teflon®, Kevlar®, poly (ethylene terephthalate) and other abrasion resistant fiber materials that can be woven into a tape or cloth. The webbed conductive fiber can be laminated or the like to materials such as Nylon®, Teflon®, polyesters, or any resin-based flexible or solid material(s), which when discretely designed in fiber content(s), orientation(s) and shape(s), will produce a very highly conductive flexible cloth-like material. Such a cloth-like material could also be used in forming electrically conductive tapes and films that can be embedded in a person's clothing as well as other resin materials such as rubber(s) or plastic(s). When using conductive fibers as a webbed conductor as part of a laminate or cloth-like material, the fibers can have diameters of between about 3 and 12 microns, typically between about 8 and 12 microns or in the range of about 10 microns, with length(s) that can be seamless or overlapping.

In some embodiments, the conductive paste is applied directly onto a cloth material or substrate made from natural or synthetic fibers described above. The matrix material in the conductive paste can be formulated to include polymers and/or copolymers that are made to provide adhesion to other solid substrates. Such electrically conductive tapes and films can find applications in electronics devices for electromagnetic shielding and grounding. Conductive tapes can be made having a coating of the conductive paste of the present technology; the conductive paste can be applied in an amount of 0.01 grams per square centimeter (g/cm²) to about 5 g/cm² to the tape substrate to provide electromagnetic shielding and grounding of electrical devices and components.

### EXAMPLES

### Example 1

### Method for Producing Copper Metal Particles

10-50 grams of copper sulfate crystals are dissolved in water to provide 500 milliliters (mL) aqueous solution, and diluted ammonium hydroxide (NH₄OH) is added to adjust the pH of the solution to 0.5-5. In another glass beaker, 3-30 g of L-ascorbic acid is dissolved in water to form a 100 ml aqueous reducing agent solution. 1-5 ml of sodium or ammonium salt of an acrylic copolymer in water are added to the reducing agent solution. Both solutions are pre-heated to 50° C. Then L-ascorbic acid solution is added to the copper sulfate solution slowly and stirred for 10 minutes. Copper particles precipitate in the solution. The mixture is heated stepwise to 60° C. and kept for an hour, and then to 70° C. and kept for an hour, to ensure the complete reaction and particle growth. The copper particles are filtered off using a Büchner funnel attached to a pump. Finally, the particles are washed with several volumes of water and dried at 40° C.

### Example 2

### Method for Producing Nickel Metal Particles

10-50 g of Nickel sulfate crystals are dissolved in water to provide 500 mL aqueous solution, and diluted NH₄OH is added to adjust the pH of the solution to 0.5-5. In another glass beaker, 10-30 g of L-ascorbic acid is dissolved in water to form a 100 ml aqueous reducing agent solution. 1-5 ml of sodium or ammonium salt of an acrylic copolymer in water are added to the reducing agent solution. Both solutions are pre-heated to 50° C. The L-ascorbic acid solution is then added to the nickel sulfate solution and stirred for 10 minutes. Nickel particles precipitate in the solution. The mixture is heated stepwise to 60° C. and kept for an hour, and then to 70° C. and kept for an hour, to ensure the complete reaction and particles growth. The nickel particles are filtered off using a Büchner funnel attached to a pump. Finally, the particles are washed with several volumes of water and dried at 40° C.

### Example 3

### Method for Producing Silver Metal Particles

10-40 g of Silver nitrate crystals are dissolved in water to provide 250 mL aqueous solution, and diluted NH₄OH is added to adjust the pH of the solution to 0.5-5. Separately, 10-40 g of L-ascorbic acid is dissolved in water to provide a 150 ml aqueous reducing agent solution, 1-5 ml of sodium or ammonium salt of an acrylic copolymer in water are added to the reducing agent solution. Both solutions are pre-heated to 50° C. The L-ascorbic acid solution is then added to the silver nitrate solution and stirred for 10 minutes. Copper particles precipitate in the solution. The mixture is heated stepwise to 60° C. and kept for an hour, and then to 70° C. and kept for an hour, to ensure the complete reaction and particles growth. The silver particles are filtered off using a Büchner funnel attached to a pump. Finally the particles are washed with several volumes of water and dried at 30° C.

The embodiments and the examples described herein are exemplary and not intended to be limiting in describing the full scope of compositions and methods of the present technology. Equivalent changes, modifications and variations of some embodiments, materials, compositions and methods can be made within the scope of the present technology, with substantially similar results.

1. A non-catalytic method for making high aspect ratio metal particles, the method comprising:
mixing a preheated metallic salt solution with a preheated reducing solution, the reducing solution comprising a carboxylic acid or salt thereof and a dispersing agent, to form a reaction mixture; and
heating the reaction mixture to a first temperature and maintaining the mixture at the first temperature for a first period of time, then heating the reaction mixture to a second temperature that is higher than the first temperature and maintaining the mixture at the second temperature for a second period of time;
wherein metal cations in the metallic salt are reduced by the reducing solution and form a plurality of crystallized metallic particles having a high aspect ratio.

2. The method according to claim 1, wherein the metal cations are selected from the group consisting of gold, silver, platinum, copper, iron, palladium, cobalt, zinc, and mixtures thereof.

3. The method according to claim 1, wherein the metallic salt solution is copper sulfate, copper-ammonium complex or silver nitrate.

4. The method according to claim 1, wherein the plurality of crystallized metallic particles comprises rod-shaped particles, cylinder-shaped particles, acicular needle-shaped particles, or combinations thereof.

5. A non-catalytic method for making non-silver metal particles, the method comprising:
mixing a preheated metallic salt solution comprising non-silver metal cations with a preheated reducing solution, the reducing solution comprising a carboxylic acid or salt thereof and a dispersing agent, to form a reaction mixture; and
heating the reaction mixture to a temperature between about 50° C. and about 80° C.;
wherein the metal cations are reduced by the reducing solution and form a plurality of crystallized non-silver metallic particles.

6. The method according to claim 5, wherein the metal cations are selected from the group consisting of gold, platinum, copper, iron, palladium, cobalt, zinc, and combinations thereof.

7. The method according to claim 5, wherein the metallic salt solution comprises copper sulfate or copper-ammonium complex.

8. The method according to claim 5, wherein the plurality of crystallized non-silver metallic particles comprises flake particles, rod-shaped particles, cylinder-shaped particles, acicular needle-shaped particles, or combinations thereof.

9. The method according to claim 5, wherein the plurality of crystallized non-silver particles comprise high aspect ratio particles.

10. The method according to claim 1, wherein the reaction mixture has a pH of from about 0.5 to about 5.0.

11. A non-catalytic method for making high aspect ratio acicular metal particles, the method comprising:
mixing a carboxylic acid or salt thereof with a dispersing agent to form a reducing solution;
adding a metallic salt solution to the reducing solution to form a precipitation mixture, the reducing solution reduces metal ions provided by the metallic salt solution to crystallize a plurality of high aspect ratio metallic particles;
heating the precipitation mixture to a temperature between about 50° C. and about 80° C.; and
collecting the plurality of high aspect ratio metallic particles from the precipitation mixture.

12. The method according to claim 11, wherein the metal ions comprises cations selected from the group consisting of gold, silver, platinum, copper, iron, palladium, cobalt, zinc, and mixtures thereof.

13. The method according to claim 11, wherein the precipitation mixture has a pH of from about 0.5 to about 5.0.

14. The method according to claim 1:
wherein the reducing solution comprises L-ascorbic acid, L-ascorbate or a mixture thereof; and/or
wherein the dispersing agent comprises a poly(ether ester), preferably a poly(dioxanone), a polyanhydrides, an acrylic polymer, a (meth)acrylic polymer, a polyolefin or a copolymer thereof.

15. (canceled)

16. The method according to claim 1, wherein the dispersing agent comprises an acrylic copolymer.

17. The method according to claim 16:
wherein the acrylic copolymer comprises two monomers selected from the group consisting of methacrylic acid, acrylic acid, methylmethacrylate, butyl acrylate, butyl methmethacrylate, and copolymers thereof; and/or
wherein the acrylic copolymer is a sodium or ammonium salt of an acrylic copolymer; and/or
wherein the acrylic copolymer is a sodium or ammonium salt of an acrylic copolymer having a density ranging from about 1.0 to about 1.5 g/cm³; and/or
wherein the acrylic copolymer has a molecular weight ranging from about 4,000 Daltons to about 400,000 Daltons; and/or
wherein the acrylic copolymer has a viscosity ranging between about 400 megapascals to about 600 megapascals; and/or
wherein the concentration of the acrylic copolymer in the reaction mixture ranges from about 5×10⁻² to about 5×10⁻⁵ Molarity.

18.-22. (canceled)

23. The method according to claim 1, wherein the high aspect ratio of the metallic particles is from about 5 to about 50.

24. The method according to claim 1, wherein the plurality of metallic particles have an acicular needle-shape.

25. The method according to claim 5, wherein the heating comprises heating the mixture to a first temperature and maintaining the mixture at the first temperature for a first period of time, then heating the mixture to a second temperature that is higher than the first temperature and maintaining the mixture at the second temperature for a second period of time.

26. The method according to claim 1, wherein the heating is at a temperature between about 50° C. and about 70° C.

27. The method according to claim 1, wherein the heating comprises heating the precipitation mixture at a first temperature of not more than 60° C. for about one hour and subsequently heating the precipitation mixture at a second temperature of about 70° C. for about one hour, as to crystallize at least 80% of the high aspect ratio metallic particles from the precipitation mixture.

28. An electrically conductive article comprising:
a non-conductive substrate; and
an electrically conductive coating disposed on at least one surface of the substrate, the coating comprising a matrix material having a plurality of metal particles, the metal particles being made by the method according to claim 1 and having an acicular shape with an aspect ratio ranging from 5 to 50.

29. The electrically conductive article according to claim 28:
wherein the substrate is a tape or a film; and/or
wherein the matrix material is an adhesive; and/or
wherein the matrix material further comprises a binder and optionally a solvent.

30.-32. (canceled)

33. A method for making a conductive article comprising a conductive paste coated on at least one surface of a substrate, the method comprising:
mixing a carboxylic acid or salt thereof with a dispersing agent to form a reducing solution;
adding a metallic salt solution to the reducing solution to form a reaction mixture, the reducing solution reduces metal ions provided by the metallic salt solution to crystallize a plurality of high aspect ratio metallic particles;
heating the reaction mixture to a temperature between about 50° C. and about 80° C.;
collecting the plurality of high aspect ratio metallic particles from the reaction mixture;
adding a matrix material to the plurality of metallic particles thereby forming the conductive paste; and
applying the conductive paste to at least one surface of the substrate.

34. The method according to claim 33, wherein the high aspect ratio metallic particles have an aspect ratio greater than 10.

35. The method according to claim 33, wherein the matrix material comprises a curable or polymerizable binder and optionally a solvent.

36. The method according to claim 33, wherein the method further comprises:
curing the matrix material using any one of actinic radiation, UV light, microwaves, e-beam, moisture, free radical initiators, and combinations thereof; and/or
curing the conductive article by heating the article in an oven preheated to a temperature of at least 100° C. for at least 30 minutes.

37. (canceled)

38. The method according to claim 33, wherein the substrate comprises one or more of a film, a tape, a cloth, a fiber, a glass, a plastic, and/or combinations thereof, and/or wherein the applying the conductive paste to the substrate comprises one or more of brush coating, spray coating, roll coating, spine coating, printing, sputtering, chemical vapor depositing, and dip coating the conductive paste to the at least one surface of the substrate.

39. (canceled)

40. An acicular metal particle having an aspect ratio greater than 5 and made according to the method of claim 1.

41. (canceled)

42. The acicular metal particle of claim 40, wherein the acicular metal particle comprises a flake particle, rod-shaped particle, cylinder-shaped particle, or acicular needle-shaped particle; and/or wherein the aspect ratio of the acicular metal particle is within a range from about 10 to about 50.

43. (canceled)

44. (canceled)

45. An electrically conductive article comprising a plurality of acicular metal particles of claim 40, wherein the electrically conductive articles comprises one or more of a matrix material, an adhesive, an electrically conductive paste, an electrically conductive coating, an electrically conductive elastomer comprising a polymer matrix loaded with a filler that includes the plurality of acicular metal particles, and/or an electromagnetic interference (EMI) shielding article.

46.-54. (canceled)
